(19) United States
(12) Patent Application Publication
(10) Pub. No.: US 2009/0284799 A1
(43) Pub. Date: Nov. 19, 2009

(54) IMAGE PROCESSING DEVICE, METHOD FOR IMAGE PROCESSING AND PROGRAM

(75) Inventor: Masatoshi Matsuhira, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/419,727

(22) Filed: Apr. 7, 2009

(30) Foreign Application Priority Data
May 14, 2008 (JP) 2008-126982

(51) Int. Cl. G06K 15/02; G06K 9/46

(52) U.S. Cl. 358/3.24; 382/195

(57) ABSTRACT

An image processing device configured to analyze image data of an image in which a person is photographed is provided. The image processing device is configured to perform a masking process of a nearly rectangular shape on an eye portion of a face of the person. The image processing device has a controller configured to detect both eyes of the person. The controller is configured to determine an inclination of the nearly rectangular shape on which the masking process is performed with respect to the image on the basis of an inclination of a straight line connecting the detected eyes.

### BACKGROUND

1. Technical Field

The present invention relates to a technology for analyzing image data and masking a portion of the image on the basis of results of the analysis.

2. Related Art

These days, an image can be easily handled as digital data. A digital still camera, for example, makes it easy to take a picture formed by digital image data of high quality. As the image data is digital, it is easy to open or distribute the captured image through a network.

Meanwhile, as an image can be easily opened or distributed, the image can be opened or distributed contrary to intention of a person photographed in the image in some cases, resulting in his or her privacy being invaded. Thus, a technique is disclosed in JP-A-2008-34963 for protecting privacy by detecting a human face from the photographed image data and performing a masking process by using a mosaic or a black bar beforehand so as to make a person photographed in the image unidentifiable.

In some cases, however, although, in the above method for protecting privacy, a masking process is performed on the detected human face, the human face may not be totally masked as a size of a portion that is hidden is too small, or a portion not to be masked is masked as the size of the hidden portion is too large. That is, in some cases, the above method has a problem in that the person is not properly masked for some unknown reason.

### SUMMARY

An advantage of some aspects of the invention is that it properly performs a masking process on a person photographed in an image.

In order to address at least some of the above problem, an aspect of the invention is to provide an image processing device configured to analyze image data of an image in which a person is photographed. The image processing device is configured to perform a masking process of a nearly rectangular shape on an eye portion of a face of the person. The image processing device has a controller configured to detect both eyes of the person. The controller is configured to determine an inclination of the nearly rectangular shape on which the masking process is performed with respect to the image on the basis of an inclination of a straight line connecting the detected eyes.

A method for image processing of the invention corresponding to the image processing device described above is provided. In the method for image processing, image data of an image in which a person is photographed is analyzed and a masking process of a nearly rectangular shape is performed on an eye portion of a face of the person. The method for image processing includes detecting both eyes of the person, and determining an inclination of the nearly rectangular shape on which the masking process is performed with respect to the image on the basis of an inclination of a straight line connecting the detected eyes.

According to the image processing device and the method for image processing of the invention, the image processing device reads image data and performs the masking process of a nearly rectangular shape on an eye portion of the person so as to make the face of the person unidentifiable. At this moment, the image processing device determines the inclination of the nearly rectangular shape on which the masking process is performed on the basis of the inclination of a straight line connecting the left and right eyes extracted from the image data.

The face of the person is photographed in the image while being directed straight to the front in one case, inclined to one side in another case, and turned sideways or obliquely in yet another case. Thus, upon detecting the face and performing the masking process, the image processing device may possibly fail to perform the masking process on the eye position. As a result, the eye often protrudes from the mask of the rectangular shape resulting in that the person is identified, or that even a portion not to be hidden is hidden. Meanwhile, if detecting the left and right eye positions of the person and determining the inclination of the rectangular shape on the basis of the inclination of a straight line connecting the eyes, the image processing device can incline the mask of the rectangular shape in accordance with the inclination of the left and right eyes even in a case where the head is inclined to one side or turned sideways and the eye position changes. Thus, the eye never protrudes from the mask of the rectangular shape so that the image processing device can provide an image in which the person is properly hidden.

The image processing device can check the inclination of the straight line connecting the left and right eye areas by using various methods. The image processing device, e.g., can select one of the sides forming an outer fringe of the image and check the inclination of the straight line connecting the left and right eye areas with respect to the selected side. Or, the image processing device can check the inclination of the straight line with respect to a direction in which pixels of the image data are arranged. In order to check the inclination of the straight line, it is enough to check the inclination with respect to a direction determined relatively to the image. The image processing device may check the inclination with respect to any direction as long as it is the inclination with respect to such a direction. In order to determine the inclination of the rectangular shape on which the masking process is performed, it is enough to determine the inclination with respect to a direction determined with respect to the image. The image processing device may determine the inclination with respect to any direction as long as the direction is determined with respect to the image.

In order to perform the masking process, the image processing device can use various methods as long as using such methods can hide the original image. The image processing device, e.g., can change a gray scale value of the image data to a gray scale value of a determined color (e.g., black) so as to paint out the original image. Or, the image processing device can perform a filtering process such as a mosaic process or a shade-off process. The image processing device can hide the original image recorded in the image data by using such methods, and can thereby make the person photographed in the image unidentifiable.

The image processing device of the invention may determine the length of the rectangular shape on which the masking process is performed on the basis of a distance between the detected left and right eyes. Even if the person in the image inclines his or her head to one side or directs his or her face sideways resulting in that the distance between the left and right eyes changes, the image processing device can thereby change the length of the rectangular shape so as to hide the left and right eyes. The image processing device can thereby hide the eyes so as to make the person unidentifiable. The image processing device can prevent the rectangular shape from reaching a portion of the image other than the face of the person. The image processing device can thereby avoid an unnatural image in which the masking process has been performed on the portion other than the face so as to provide an image of good quality.

In a case where only one of the eyes has been detected from the image, the image processing device of the invention can set the inclination of the rectangular shape to be equal to the inclination of the detected one eye.

In a case where only one of the eyes is photographed in the image, it is conceivable that the face of the person is nearly completely, or at least significantly, turned sideways. Thus, the image processing device can make the person unidentifiable by hiding the one eye photographed in the image. The image processing device can set the inclination of the rectangular shape to be equal to the inclination of the detected one eye so as to exactly hide the one eye and to make the person unidentifiable.

In a case where it is difficult to detect the inclination of the eye, the image processing device can use a preset inclination (e.g., “zero degrees”). In such a case, the image processing device can sufficiently hide the one eye, and can make the person unidentifiable.

Upon detecting only one of the eyes of the person from the image, the image processing device of the invention may determine the length of the rectangular shape on the basis of the size of the detected one eye.

The image processing device can sufficiently hide the eye even in the image in which only the one eye is photographed by changing the length of the rectangular shape in accordance with the size of the eye, so as to protect privacy of the person more exactly. The image processing device can prevent the rectangular shape from reaching a portion other than the face of the person, so as to avoid performing the masking process on the portion other than the face and producing an unnatural image. The image processing device can thereby provide an image of good quality.

The invention may be implemented by using a computer that reads a program for implementing the method for image processing described above and performs determined functions. Thus, the invention includes an aspect of the program as described below. That is, the program of the invention is one for implementing a method for image processing by using a computer. In the method for image processing, image data of an image in which a person is photographed is analyzed and a masking process of a nearly rectangular shape is performed on an eye portion of a face of the person. The method includes detecting both eyes of the person, and determining an inclination of the nearly rectangular shape on which the masking process is performed with respect to the image on the basis of an inclination of a straight line connecting the detected eyes.

Upon reading the program and performing the above functions, the computer can properly perform the masking process on the person in the image.

### BRIEF DESCRIPTION OF THE DRAWINGS

The invention will be described with reference to the accompanying drawings, wherein like numbers reference like elements.

FIG. 1 is a perspective view showing a printer having an image processing device of an embodiment of the invention.

FIG. 2 is a flowchart showing a flow of a “printing process adapted for protecting privacy” of the embodiment.

FIG. 3 shows an example of an image on which the masking process is performed.

FIG. 4 illustrates a state in which eye areas have been detected from the image.

FIGS. 5A and 5B illustrate a state in which the image processing device checks an angle of an inclination from the positions of the eye areas and determines an angle of an inclination of a mask area.

FIG. 6 illustrates a state in which the image processing device determines the angle of the inclination of the mask area on the basis of the positions of the left and right eye areas.

FIG. 7 illustrates a state in which the mask area is set in the image.

FIG. 8 illustrates a state in which the image processing device determines the length of the mask area on the basis of the distance between the left and right eye areas.

FIG. 9 illustrates a state in which the masking process is performed on the image.

FIG. 10 illustrates a state in which the eye protrudes from the mask area in a case where the person inclines her head to one side.

FIGS. 11A and 11B illustrate a state in which the image processing device can properly set the mask area on an image in which a person inclines her head to one side.

FIG. 12 illustrates a state in which the image processing device sets the mask area on an image in which only one of the eyes is photographed.

FIG. 13 illustrates a state in which the image processing device determines the length of the mask area in the image in which only one of the eyes is photographed.

### DESCRIPTION OF EXEMPLARY EMBODIMENTS

An embodiment of the invention will be explained in the order shown below so as to clarify details of the invention described above.

### A. Device Configuration

### B. Printing Process Adapted for Protecting Privacy

### C. Modifications

### A. Device Configuration

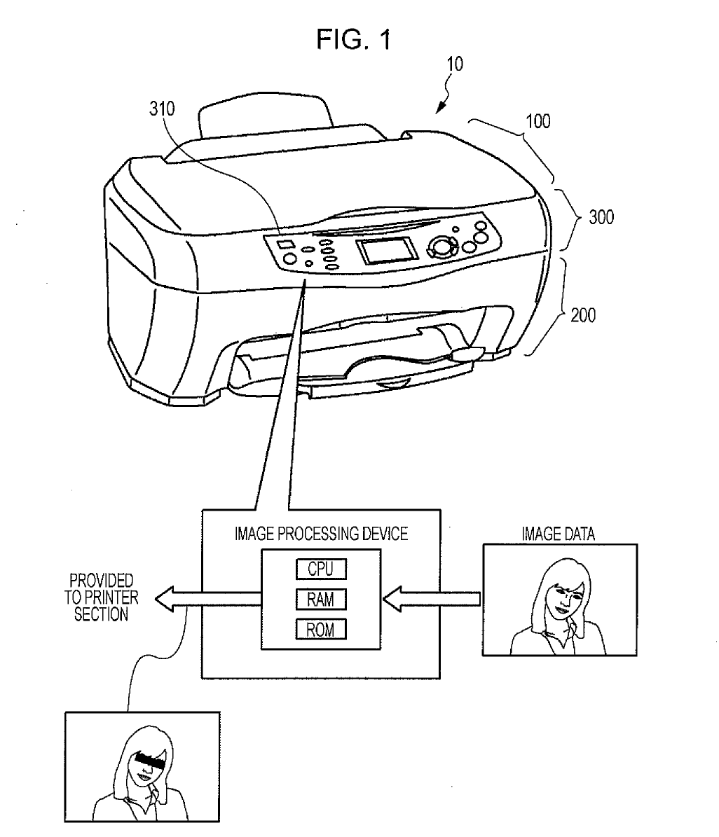

FIG. 1 is a perspective view showing a printer 10 having an image processing device of the invention. As shown in FIG. 1, the printer 10 is constituted by a scanner section 100, a printer section 200, a controller section 300 configured to control operations of the scanner section 100 and the printer section 200, and so on. The scanner section 100 has a scanner function for reading a printed image and producing image data. The printer section 200 has a printer function for receiving the image data and printing the image on a printing medium. The printer 10 can implement a photocopier function by producing an image read by the scanner section 100 by means of the printer section 200. That is, the printer 10 of the embodiment is a so-called multifunction printer that can work as a scanner, a printer and a photocopier by itself.

The controller section 300 has a CPU, a ROM, a RAM and so on. The controller section 300 is configured to perform a determined process on the image data read by the scanner section 100 or read from a recording medium such as a memory card, and then print the image. The controller section 300 is configured, e.g., to analyze the image data so as to detect a person, and to perform a masking process such as painting out a portion of the person's eyes with a rectangular shape. The controller section 300 can thereby print an image in which the person's privacy is protected. In order to print such an image, however, it is important that the masking process be performed on a proper portion of the image. Upon not being performed on the proper portion, the masking process may possibly produce inconvenience such that the face is not masked resulting in unprotected privacy or that a portion not to be masked is masked resulting in an unnatural image. In order to address the above inconvenience, the printer 10 of the embodiment has the image processing device of the invention configured to perform the masking process on the proper portion of the image.

FIG. 1 shows the printer 10 including the image processing device of the embodiment. As shown in FIG. 1, the image processing device is constituted by the CPU, the RAM and so on included in the controller section 300, and is configured to perform various processes by using functions of the CPU, the RAM and so on. After receiving image data, the image processing device of the embodiment analyzes the image data and detects the eyes of a person photographed in the image. The image processing device masks a portion including the eyes with a rectangular shape so as to protect the persons privacy. At this moment, the image processing device of the embodiment performs a specific process on the basis of the position of the detected eyes so as to properly perform the masking process. The image processing device provides the printer section 200 with the image data that the masking process has been performed on, so that an image to be printed in which the person's privacy is properly protected can be produced. Hereinafter, the above process for printing an image in which privacy is protected will be explained in detail with reference to a flowchart.

### B. Printing Process for Adapted for Protecting Privacy

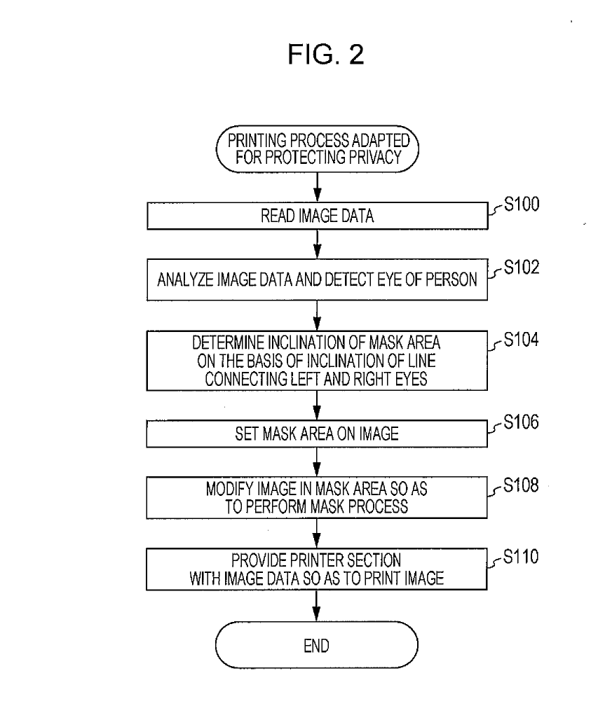

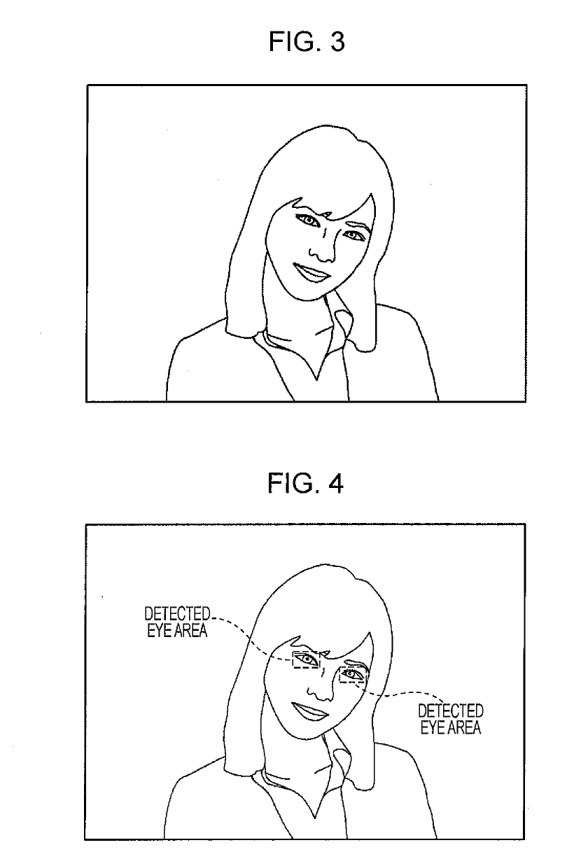

FIG. 2 is a flowchart showing a flow of a “printing process adapted for protecting privacy” of the embodiment. When a user operates an operation panel 310 so as to specify image data to be printed, the controller section 300 starts the above process. As shown in the flowchart in FIG. 2, after the process starts, the image processing device first reads the image data to be printed (step S100). The image data to be read may be recorded on a recording medium that the printer 10 is loaded with such as a memory card, or recorded on a computer connected to the printer 10. It is assumed that the image processing device reads an image shown in FIG. 3 from the memory card.

After reading the image data, the image processing device then analyzes the image data and detects the “eyes” of a person photographed in the image so as to perform the masking process (step S102 shown in FIG. 2). Various methods can be used for detecting the “eyes”. The image processing device can use, e.g., a method for pattern matching by using a template. That is, the image processing device stores a typical pattern of the “eyes” as the template, and searches the image for a portion that is similar to the template. The image processing device stores, as the typical pattern of an “eye”, e.g., a pattern in which a black circle (corresponding to an iris) appears at the center of a gray ellipse corresponding to the white of the eye. The image processing device analyzes the image data and searches the image for a portion that is similar to the pattern. If the image includes such a portion, the image processing device can judge that an eye appears in that portion and can thereby detect the eye.

When trying to detect eyes by using the pattern matching method and so on, however, the image processing device has to search the whole image for the eyes, resulting in taking some time to detect the eyes. Thus, the image processing device may detect a face before detecting the eyes, and then search the detected face for the eyes. Then, the image processing device detects the eyes by applying the pattern matching method described above to the portion of the face. As an area in which the image processing device searches for the eyes is thereby limited to the portion of the face, the image processing device can detect the eyes more quickly. As a matter of course, the image processing device is not limited to use the above method, and can detect the eyes by using various methods.

FIG. 4 illustrates a state in which the eyes have been detected from the image data. As shown in FIG. 4, an area including an eye (eye area) has been detected at each of the positions of the left and right eyes. Although the detected eye area shown in FIG. 4 has a rectangular shape, the shape of the eye area is not limited to rectangular and may be another shape. If the image processing device searches for an elliptical pattern corresponding to an eye and detects an eye, the shape of the eye area may be elliptical.

After detecting the eye area, the image processing device sets a rectangular area on which the masking process is performed (mask area) in the image. The “printing process adapted for protecting privacy” of the embodiment has a feature for properly setting the mask area in which the image processing device checks an inclination of the face on the basis of the positions of the left and right eye areas and sets the mask area to be inclined in accordance with the inclination of the face. The image processing device can thereby properly perform the masking process for various images in which a person is photographed, which will be described later in detail.

In the “printing process adapted for protecting privacy” of the embodiment, the image processing device draws a straight line to connect the left and right eye areas so as to check the inclination of the face, and obtains an angle of the inclination of the straight line. If the face is inclined, the line connecting the left and right eyes should be inclined accordingly, and the image processing device can thereby grasp the inclination of the face. In order to set the mask area at a more proper inclination, it is important that the inclination of the face be obtained accurately. Thus, in order to properly set the mask area, the image processing device of the embodiment obtains the angle of the inclination of the face by drawing the straight line by using a method shown below.

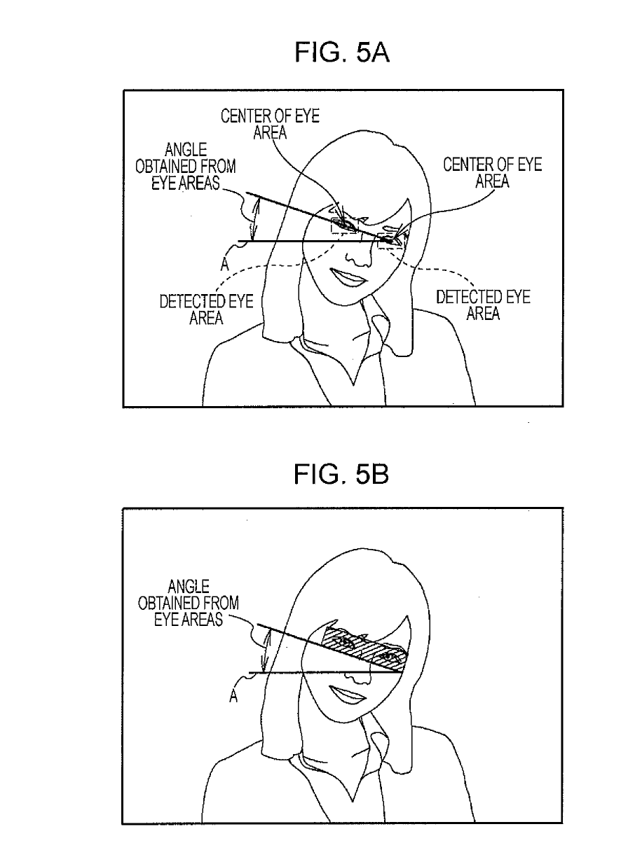

FIGS. 5A and 5B illustrate a state in which the image processing device draws the straight line to connect the left and right eye areas, obtains the angle of the inclination of the line, and determines the inclination of the mask area on the basis of the obtained angle. FIG. 5A illustrates a state in which the image processing device draws the straight line to connect the left and right eye areas and obtains the angle of the inclination of the line. As shown in FIG. 5A, the image processing device finds a central point in each of the left and right eye areas, and draws the straight line to connect the left and right central points. The image processing device can easily find the central point of the eye area by estimating a position of the center of balance of pixels in the eye area. As shown in FIG. 5A, the image processing device can approximately connect the centers of the eyes by drawing the straight line as described above. Thus, the image processing device can draw a straight line that precisely represents the inclination of the face. It is enough to estimate the position of the center of balance of pixels in each of the eye areas and to connect both of the above positions. The image processing device need not analyze the shape of the eye area in detail, and can thereby simply draw the straight line.

After drawing the straight line between the left and right eye areas as described above, as shown in FIG. 5A, the image processing device obtains the inclination of the straight line with respect to the horizontal direction of the image (direction of a straight line indicated by “A”). Then, the image processing device determines that the angle of the inclination of the mask area is equal to the obtained angle. The image processing device can thereby set the mask area to be inclined in accordance with the face.

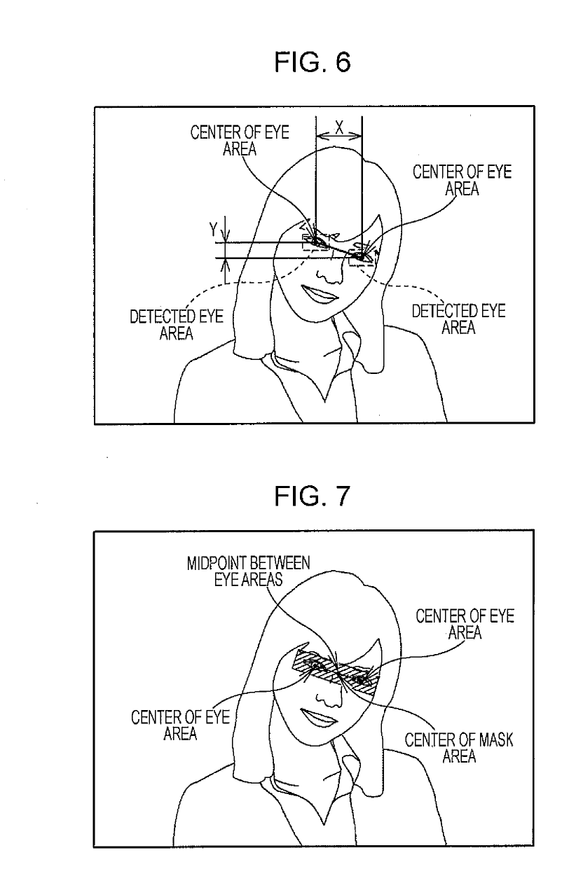

Instead of determining the inclination of the mask area after finding the angle of the straight line connecting the eye areas, the image processing device may directly determine the inclination of the mask area on the basis of the central positions of the two eye areas. As shown in FIG. 6, e.g., the image processing device may calculate a distance between the eye areas in the horizontal direction (indicated by “X” in FIG. 6) and a distance between the eye areas in the vertical direction (indicated by “Y” in FIG. 6) on the basis of the central positions of the eye areas. Then, the inclination of the straight line connecting the central positions of the eyes can be represented as “Y/X” and the image processing device may determine that the inclination of the mask area is “Y/X” accordingly. The image processing device can thereby incline the mask area in accordance with the inclination of the face. As the distances “X” and “Y” can be easily calculated from the central positions of the eyes, the image processing device can determine the inclination of the mask area in a simpler manner. After determining the inclination of the mask area by using any of the various methods described above, the image processing device then performs a process for actually setting the mask area on the image (Step S106 shown in FIG. 2).

FIG. 7 illustrates a state in which the mask area is set in the image. The image processing device can determine the position on which the mask area is set by using various methods. As shown in FIG. 7, e.g., the image processing device finds the midpoint between the eye areas and sets the mask area in such a way that the center of the mask area is at the midpoint. As the position of the midpoint can be easily found from the central positions of the eye areas previously found, the image processing device can thereby simply set the mask area. As a matter of course, the image processing device is not limited to using the above method and can set the mask area by using any of various methods. If the image processing device analyzes the image data and detects an area in which the face is drawn, the position of the eyes can roughly be estimated on the basis of the position of the area of the face, and thus the image processing device may set the mask area at the estimated position.

The image processing device can determine the length of the mask area by using various methods. The image processing device may detect the face area from the image and determine the length of the mask area on the basis of the width of the detected face area. The image processing device can thereby set a mask area of a proper length in accordance with the width of the face. The image processing device can determine the length of the mask area on the basis of the eye area, instead of the face area. The image processing device of the embodiment determines the length of the mask area on the basis of the positions of the eye areas in order to more properly set the length of the eye area.

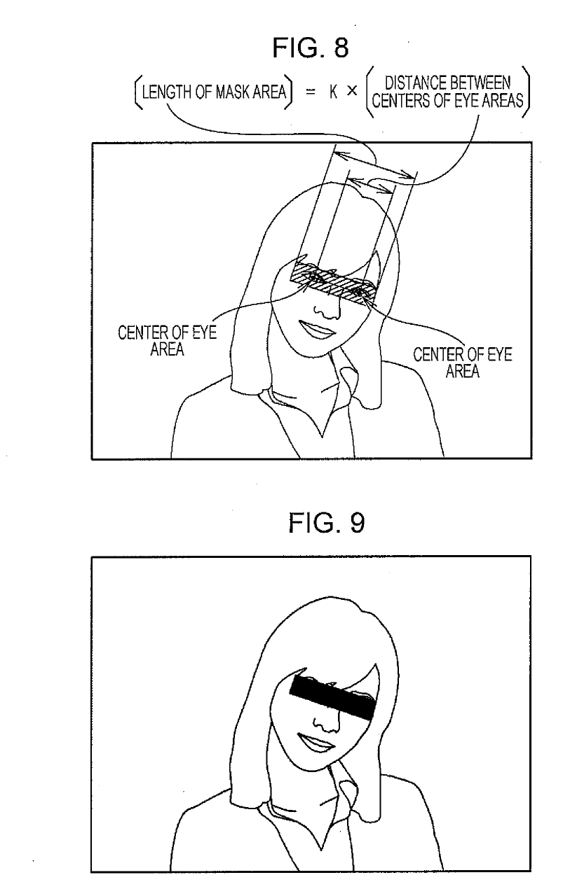

FIG. 8 illustrates a state in which the image processing device determines the length of the mask area on the basis of the positions of the eye areas. As shown in FIG. 8, the image processing device obtains a straight distance between the left and right eye areas and multiplies the distance by a determined coefficient (indicated by “K”, in FIG. 8) so as to determine the length of the mask area. The coefficient “K” should be given a proper value in such a way that the mask area is long enough to mask the eye area upon giving the coefficient “K” a proper value, the image processing device can avoid a problem of performing the masking process on a portion other than an eye resulting in making the image unnatural. Upon giving the coefficient “K” a value around “1.5”, the image processing device can sufficiently mask the eye area and can avoid a problem in which the mask area reaches a portion other than the face.

The image processing device may determine the length of the mask area by referring to a look-up table that determines the length of the mask area, instead of multiplying the distance by the coefficient “K”. That is, the length of the mask area that is suitable for the distance between the eye areas is checked beforehand, and the image processing device stores a look-up table that associates the checked length of the mask area with the distance between the eye areas. Then, the image processing device determines the length of the mask area by referring to the look-up table on the basis of the distance between the eye areas obtained from the image data. As the length of the mask area can thereby be set exactly for each value of the distance between the eye areas, the image processing device can more properly set the length of the mask area. Meanwhile, as it is enough to perform a simple calculation shown in FIG. 8 if the length of the mask area is determined in accordance with the equation shown in FIG. 8, the image processing device can determine the length of the mask area in a simpler manner.

After setting the mask area as described above, the image processing device actually modifies the image data in the mask area so as to perform the masking process (step S108 shown in FIG. 2). The image processing device can perform the masking process by using various methods, and it can be performed simply by changing a gray scale value of the image data in the mask area to another gray scale value. As shown in FIG. 9, e.g., the image processing device changes a gray scale value of the image data in the mask area to a gray scale value of black. As the mask area is painted out with black after the gray scale value is changed, as shown in FIG. 8, the image processing device can hide the eyes of the person drawn in the mask area. Thus, the image processing device can produce image data in which the privacy of the person is protected.

As a matter of course, the image processing device is not limited to using the above method and can perform the masking process by using another method. The image processing device may perform a so-called mosaic process on the image data in the mask area, or may perform a shade-off process by using a shade-off filter such as a Gaussian filter. The image processing device can hide the eyes of the person drawn in the mask area in such cases, and can thereby obtain image data in which the privacy of the person is protected.

After producing image data in which the privacy of the person is protected, the controller section 300 provides the printer section 200 with the image data. Then, the printer section 200 prints the image on the basis of the provided image data (step S110 shown in FIG. 2). Thus, a printed image in which the privacy of the person is protected is provided. After printing the image as described above, the controller section 300 ends the “printing process adapted for protecting privacy”.

According to the “printing process adapted for protecting privacy” of the embodiment, as described above, the image processing device detects the eye areas from the image data and determines the inclination of the mask area on the basis of the positions of the detected eye areas (refer to FIG. 7). The image processing device can thereby properly perform the masking process on various images. This aspect will be described in detail below.

Generally speaking, a human face photographed in an image is not only photographed while being directed straight to the front, but is photographed in various states. In some cases, the human face is photographed while being inclined to one side, turned sideways or obliquely. As a face is photographed in various states image by image, as a matter of fact, attempting to detect a face so as to perform the masking process never succeeds in some cases. As a result, a human eye protrudes from the mask area and the person can be identified in some cases.

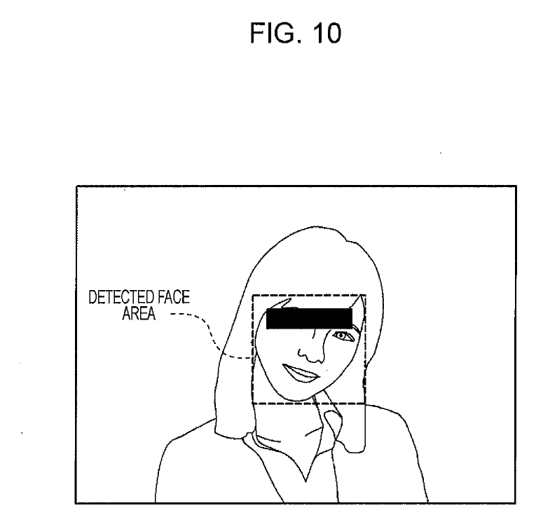

FIG. 10 illustrates a state in which a human eye protrudes from the mask area. In the example shown in FIG. 10, the image processing device detects an area in which a face appears (indicated by a dashed line in FIG. 10) from the image and estimates positions where the eyes are located on the basis of the face area so as to perform the masking process on the estimated area. In an image in which a human face is directed straight to the front, the image processing device can hide the human eye by using the above method. As the person inclines her head to one side in the image shown in FIG. 10, however, one of the eyes protrudes from the mask area, and the person can be identified due to the eye that protrudes from the mask area.

Meanwhile, according to the “printing process adapted for protecting privacy” of the embodiment, the image processing device grasps the inclination of the face on the basis of the positions of the left and right eye areas and sets the mask area to be inclined in accordance with the inclination of the face. Thus, even if the person in the image inclines her head to one side, the image processing device can set the mask area to be inclined accordingly, and there is no chance that the person can be identified due to one of her eyes that protrudes from the mask area (refer to FIG. 5). Thus, the image processing device can properly protect the privacy of the person photographed in the image.

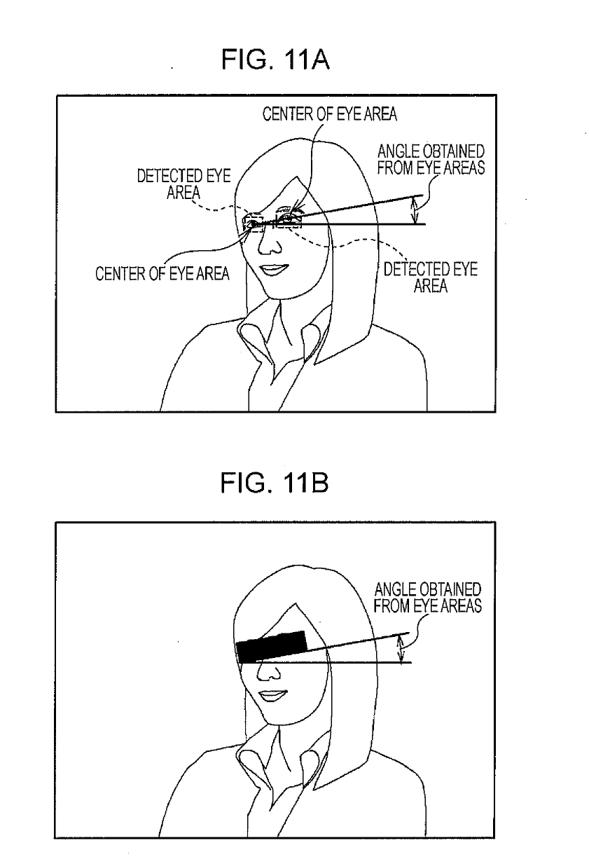

According to the “printing process adapted for protecting privacy” of the embodiment, the image processing device can properly perform the masking process not only in a case where a photographed person inclines his or her head to one side, but also in a case where the face is turned sideways or obliquely. FIGS. 11A and 11B illustrate a state in which the image processing device performs the masking process in an image in which a human face is turned sideways, In such a case where the human face is turned sideways as shown in FIGS. 11A and 11B, the left and right eyes are positioned to be more or less relatively inclined. Unless the mask area is properly set, an eye protrudes from the mask area and the person can be identified in some cases. According to the “printing process adapted for protecting privacy” of the embodiment, as shown in FIG. 11A, the image processing device can obtain the angle of the inclination of the eyes on the basis of the positions of the left and right eye areas, and can set the mask area in accordance with the inclination of the eyes. Thus, the image processing device can properly perform the masking process in such an image (refer to FIG. 11B).

According to the “printing process adapted for protecting privacy” of the embodiment, it is enough to approximately detect the positions of the eye areas, and the image processing device can properly set the mask area without detecting the eye areas with high accuracy. That is, if by approximately detecting the positions of the eye areas, the image processing device can determine the inclination of the mask area on the basis of the detected positions, the image processing device thus need not completely detect the “eyes”. In a case where some hairs are covering an eye or a shadow is cast on an eye, e.g., it is difficult to detect a portion of the eye on which the hairs or the shadow exists, and the image processing device cannot detect such a portion in some cases. In such a case, the image processing device cannot perform the masking process on the portion that cannot be detected (on which the hairs or the shadow exist), and the person may consequently be identified. Meanwhile, according to the embodiment, if detecting a portion of each of the eyes, the image processing device can grasp the inclination of the face on the basis of the above portion and set the mask area to be inclined. Thus, even if there is a portion to be hardly detected (a portion on which the hairs or the shadow exist), the image processing device can properly perform the masking process and properly protect the privacy. Thus, the image processing device thereby need not detect the eyes with high accuracy, and can thereby simplify the detection process and quickly print the image.

According to the “printing process adapted for protecting privacy” of the embodiment, as described above, the image processing device determines the inclination of the mask area on the basis of the positions of the left and right eye areas so as to properly perform the masking process in various images. As the privacy of the person photographed in the image is precisely protected, the image processing device enables the user to easily print the image without being worried about the privacy or the right to refuse to be photographed.

According to the embodiment, the image processing device determines the length of the mask area on the basis of the distance between the eye areas (refer to FIG. 8), and thus can set the mask area of a proper length in various images in which a person is photographed, which will be complimentarily explained.

As the direction of the human face is various image by image, as described above, the mask area may be too long in some images. In an image in which the face shown in FIG. 11A is turned sideways, e.g., the face is turned sideways and the width of the face is reduced accordingly. Thus, the mask area is too long in comparison with the width of the face, and the mask area possibly protrudes from the face.

Meanwhile, the image processing device of the embodiment determines the length of the mask area on the basis of the distance between the left and right eye areas, and thus can set the mask area of a proper length in such an image. That is, if the face is turned sideways, the distance between the left and right eye areas is reduced as much accordingly. The image processing device determines the length of the mask area on the basis of the reduced distance, and thus can set the mask area of the proper length that does not protrude from the face. Thus, the image processing device can avoid performing the masking process on a portion other than the face and producing an unnatural image, and can obtain an image of good quality.

### C. Modifications

The image processing device of the embodiment described above detects both the left and right eye areas so as to properly set the mask area. The image processing device can properly set the mask area, however, even if detecting only one of the eye areas.

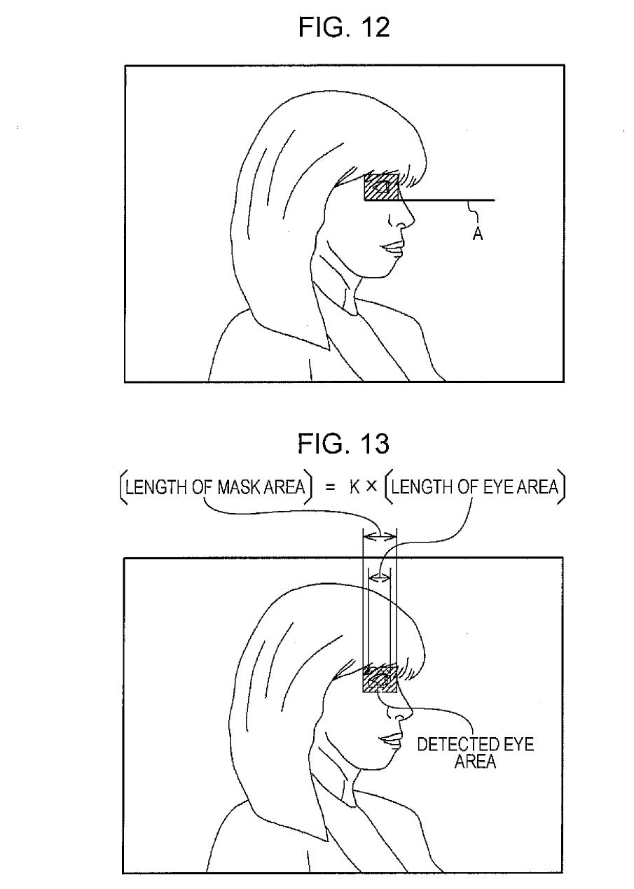

FIG. 12 illustrates a state in which the image processing device sets the mask area in an image in which one of the eye areas is detected. As shown in FIG. 12, the face is turned sideways nearly completely and only one of the eye areas is photographed in the image. Thus, as a matter of course, only one of the eye areas is detected. Generally speaking, if only one of the eye areas is detected, it is conceivable that the face is nearly completely, or at least significantly, turned sideways as in the image shown in FIG. 12. Thus, it is conceivable that the image processing device can make the person unidentifiable in like images by hiding only the one eye.

Thus, upon detecting only one of the eye areas, the image processing device sets the mask area while regarding the angle of the inclination of the face as “zero degrees” without checking the angle of the inclination of the face in detail. That is, as shown in FIG. 12, the image processing device sets the mask area along the horizontal direction of the image (direction of a line indicated by “A” in FIG. 12) in such a way that the angle of the inclination of the mask area is “zero degrees”. Even if regarding the inclination of the face as “zero degrees”, the image processing device can sufficiently hide the one eye. Thus, the image processing device can make the person unidentifiable and can easily protect the privacy.

As a matter of course, the image processing device may analyze the image in detail so as to grasp the inclination of the face, and set the mask area to be inclined in accordance with the inclination of the face. Upon analyzing the image data of the eye area and detecting an outline of the eye, e.g., the image processing device can estimate the inclination of the face from the inclination of the eye. Thus, the image processing device may set the mask area to be inclined in accordance with the estimated inclination of the face. The image processing device can thereby more properly set the mask area in accordance with the inclination of the face.

The image processing device can properly set the length of the mask area. FIG. 13 illustrates a state in which the image processing device determines the length of the mask area in an image in which one of the eye areas is detected. As shown in FIG. 13, the image processing device finds out the length of the detected one eye area and multiplies the length of the eye area that is found out by a preset coefficient (indicated by “K” in FIG. 13) so as to determine the length of the mask area. The image processing device can sufficiently hide the one eye, and can thereby make the person unidentifiable. If the coefficient “K” is given a proper value, the mask area does not reach a portion other than the face. The image processing device can thereby avoid performing the masking process on the portion other than the face and producing an unnatural image. Even in an image in which only one eye is photographed, as described above, the image processing device can properly protect privacy and provide an image of good quality without an unnatural feeling. The image processing device may obtain the length of the eye area in any way, and it is preferable to obtain the length in the longer side direction as shown in FIG. 13, as a problem in that a portion of the eye protrudes from the mask area can be avoided.

The image processing device has been described above. The invention is not limited to the overall embodiment and modifications described above, and can be implemented in various manners within the scope of the invention.

As described above, the image processing device of the embodiment is included in the printer. The image processing device of the embodiment can be included in a photograph printer such as a so-called minilab device. The image processing of the embodiment can be included in an unmanned photograph printer terminal placed on a street corner or in a public space. Also in such cases, the image processing device can properly perform the masking process on a person and can thereby easily provide an image in which privacy or a right to refuse to be photographed is protected.

The image processing device of the embodiment can be included in a digital still camera. Upon being included in the digital still camera, the image processing device analyzes an image photographed by the user and perform the masking process on a person photographed in the image. As the masking process is thereby properly performed on the person, the user can easily distribute or open the image by uploading it on a website and so on without worrying about the privacy or the right to refuse to be photographed.

As a matter of course, the image processing device of the embodiment can be included not only in the printer device or the digital still camera but in various devices. The image processing device can be included in an image display device such as a liquid crystal display monitor or a CRT display monitor, and in a mobile display device such as a photo viewer or a mobile phone terminal. Also in such cases, the image processing device can properly perform the masking process on a person and can thereby provide an image in which privacy or a right to refuse to be photographed is exactly protected.

The present application claims the priority based on a Japanese Patent Application No. 2008-126982 filed on May 14, 2008, the disclosure of which is hereby incorporated by reference in its entirety.

What is claimed is:

1. An image processing device configured to analyze image data of an image in which a person is photographed, the image processing device being configured to perform a masking process of a nearly rectangular shape on an eye portion of a face of the person, comprising:
a controller configured to detect both eyes of the person, the controller being configured to determine an inclination of the nearly rectangular shape on which the masking process is performed with respect to the image on the basis of an inclination of a straight line connecting the detected eyes.

2. The image processing device according to claim 1, wherein the controller is further configured, in a case where only one of the eyes of the person is detected from the image, to make the inclination of the nearly rectangular shape on which the masking process is performed equal to an inclination of the one eye.

3. The image processing device according to claim 1, wherein the controller is further configured, in a case where only one of the eyes of the person is detected from the image, to determine a size of the nearly rectangular shape on which the masking process is performed in a longer side direction on the basis of a size of the one eye.

4. A method for image processing, in which image data of an image in which a person is photographed is analyzed and a masking process of a nearly rectangular shape is performed on an eye portion of a face of the person, comprising:
detecting both eyes of the person; and
determining an inclination of the nearly rectangular shape on which the masking process is performed with respect to the image on the basis of an inclination of a straight line connecting the detected eyes.

5. A program for implementing a method for image processing by using a computer, in which image data of an image in which a person is photographed is analyzed and a masking process of a nearly rectangular shape is performed on an eye portion of a face of the person, the method comprising:
detecting both eyes of the person; and
determining an inclination of the nearly rectangular shape on which the masking process is performed with respect to the image on the basis of an inclination of a straight line connecting the detected eyes.
